(19) United States
(12) Patent Application Publication
(10) Pub. No.: US 2014/0171191 A1
(43) Pub. Date: Jun. 19, 2014

(54) COMPUTATIONALLY GENERATING TURN-BASED GAME CINEMATICS

(71) Applicant: MICROSOFT CORPORATION, Redmond, WA (US)

(72) Inventors: Anthony J. Cox, Seattle, WA (US); Stephen G. Dewhurst, Kirkland, WA (US); Thomas J. Zuccotti, Seattle, WA (US); James Lawrence Ricker, Vancouver (CA); William Ben Hanke, Vancouver (CA)

(73) Assignee: MICROSOFT CORPORATION, Redmond, WA (US)

(21) Appl. No.: 13/720,647

(22) Filed: Dec. 19, 2012

(51) Int. Cl. A63F 13/00

(52) U.S. Cl. CPC A63F 13/00
USPC 463/31

(57) ABSTRACT

Systems and methods for computationally generating a cinematic animation in a turn-based game program are provided. In one aspect, a phase intensity scoring engine is configured to receive a turn report at a conclusion of a turn, divide it into turn phases, and score the intensity of each phase, so that an animation sequence template may be populated with the turn phases based on their intensity scores. At least one action sequence template is selected for each turn phase, and an action sequence instance is created for each action sequence template based upon game data. Action sequence instances for each turn phase are rendered to produce a cinematic visually animation summarizing the turn.

### BACKGROUND

In turn-based game programs, players perform actions in discrete turns, as opposed to playing synchronously in real time. Turn-based games have recently become popular on mobile computing devices, such as smartphones and tablets. These games have relatively simple, two-dimensional graphical user interfaces, which may contain text, graphics, and simple animated icons, and which do not overburden the processing power of such mobile computing devices. However, one drawback of current turn-based games is that they lack the visual interest of games that feature real-time three-dimensional rendered video. This is due to hardware constraints of mobile computing devices, such as lower processing speeds and reduced power consumption, which prevent such devices from rendering video quickly enough for compelling real time, synchronous game play. As a result, turn-based games on mobile computing devices currently suffer from a lack of visual interest.

### SUMMARY

To address these issues, systems and methods for computationally generating a cinematic animation in a turn-based game program are provided. In one aspect of the system, a turn report is received at a conclusion of a turn of the turn-based game program. From the turn report, a plurality of turn phases in sequential order is identified within the turn, each turn phase including one or more game events. An intensity graph is then computed for the turn. The intensity graph includes an intensity score for each turn phase that is determined based upon the game events in that turn phase. A subset of phases is identified as those phases having at least threshold intensity scores or having higher intensity scores than a remainder of the phases. A sequence template is populated with one or more of the phases in the subset, and for each phase in the sequence template, at least one action sequence template is selected from an action template library. For each selected action sequence template, a respective action sequence instance is created based upon game data for the phase associated with the selected action template. The action sequence instance for each identified phase is rendered, to thereby produce the cinematic animation for the turn of the turn-based game program. The rendered cinematic animation is then outputted to a display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an embodiment of a system for computationally generating a cinematic animation in a turn-based game program.

FIG. 2 schematically shows an embodiment of a software processing pipeline implemented by the system of FIG. 1.

FIG. 3 schematically shows an example of a computationally generated cinematic animation displayed within a graphical user interface of a turn based game program client executed on a client device of the system of FIG. 1.

FIG. 4 shows a method for computationally generating a cinematic animation in a turn-based game program according to an embodiment of the present disclosure.

FIG. 5 schematically shows an example of a computing device that may be used as the client devices or server of the system of FIG. 1.

### DETAILED DESCRIPTION

The present disclosure is directed to computationally generating a cinematic animation in a turn-based game program. As described in further detail below, a turn report summarizing game events in a turn is segmented into turn phases which represent discrete blocks of time in the turn. Intensity scores are assigned to, and quantify the importance of, each turn phase. The intensity scores are used to select a sequence template which generally describes one or more of the turn phases. The template is then populated with specific aspects of the one or more turn phases. A cinematic animation is generated and rendered based on the one or more turn phases and their specific aspects, providing an engaging and customized visual summary of game events to a user, with a timeline control that enables the user to scroll back and replay certain phases, as desired.

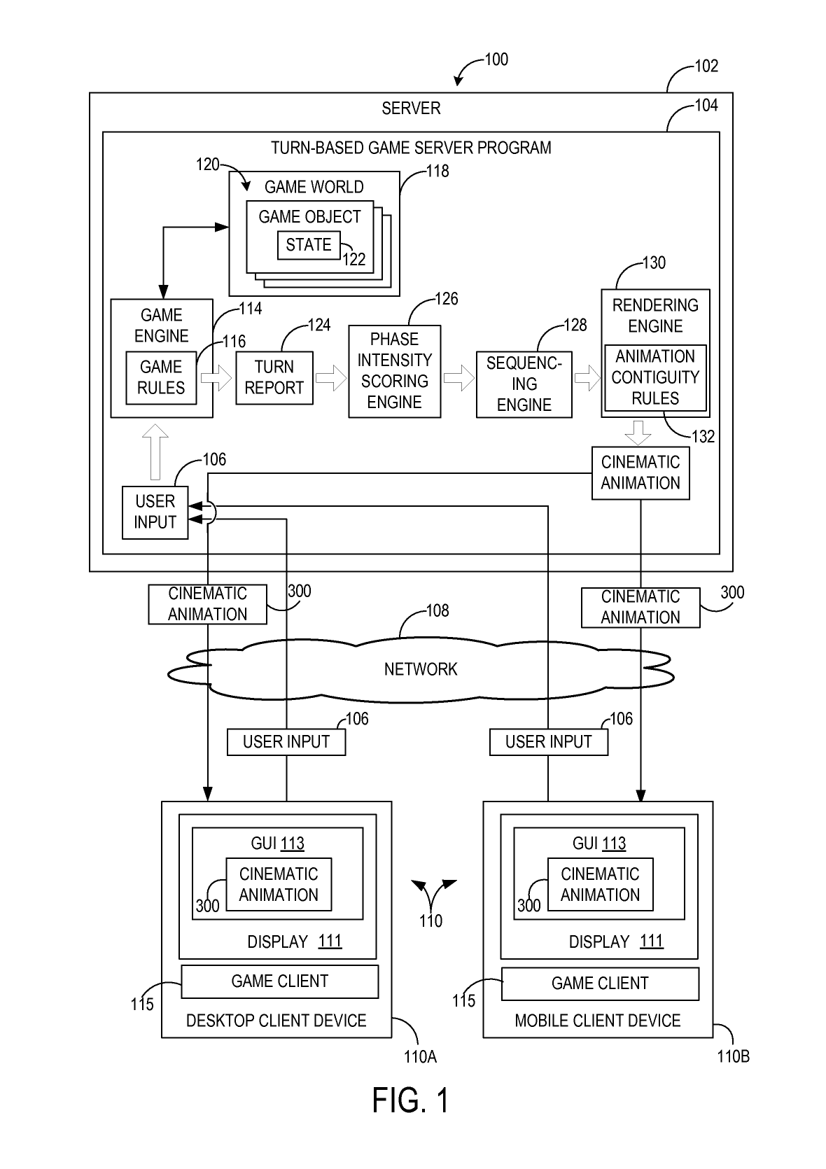

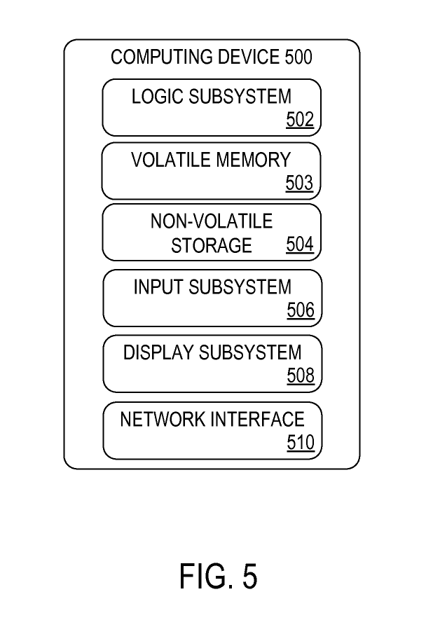

FIG. 1 schematically shows an embodiment of a system 100 for computationally generating a cinematic animation in a game program. System 100 includes a server 102 executing a turn-based game sever program 104. Server 102 may be any suitable device for executing program 104, and may be, for example, computing device 500 described below with reference to FIG. 5. Server 102 may receive user input 106 over a network 108, which may be any suitable network including those described below with reference to FIG. 5. User input 106 may comprise instructions or other information controlling various aspects of program 104, described in further detail below. In the example shown, server 102 receives user input 106 from client devices 110, such as desktop client device 110A and mobile client device 110B, though it will be appreciated that user input may be received from any number and type of suitable devices without departing from the scope of this disclosure. Such suitable devices are discussed below with reference to FIG. 5.

Program 104 includes a game engine 114 facilitating the execution of a turn-based game program, which may be a multiplayer game played by one or more players. Game engine 114 includes game rules 116 which control how the execution of program 104 proceeds, particularly handling how user input 106 affects a game world 118. Game world 118 includes a spatial representation of the gamespace in which the game is carried out, such as a three dimensional model. The game world further includes a plurality of game objects 120, such as player characters which are player controllable and non-player characters which are controlled by the game program, as well as artifacts with which the PCs and NPCs interact with within the gamespace.

Game objects 120 may be controlled to perform various actions, for example creating and/or destroying other game objects, moving throughout the virtual gamespace, activating special abilities, etc. Further, each game object in the plurality of game objects 120 includes a state 122 which represents a condition of each game object. For example, state 122 may encode a game object's health, rate of movement, availability of special abilities, etc.

The state of a game object may change based on interactions within the game as the game progresses. As these interactions occur, game engine 114 may utilize game rules 116 to alter the state 122 of game objects 120 in game world 118, at each turn of the turn-based game program. Program 104 is configured to generate a turn report 124 summarizing the events that have occurred in each turn and the state of the game objects affected by each turn, based on the output received from game engine 114.

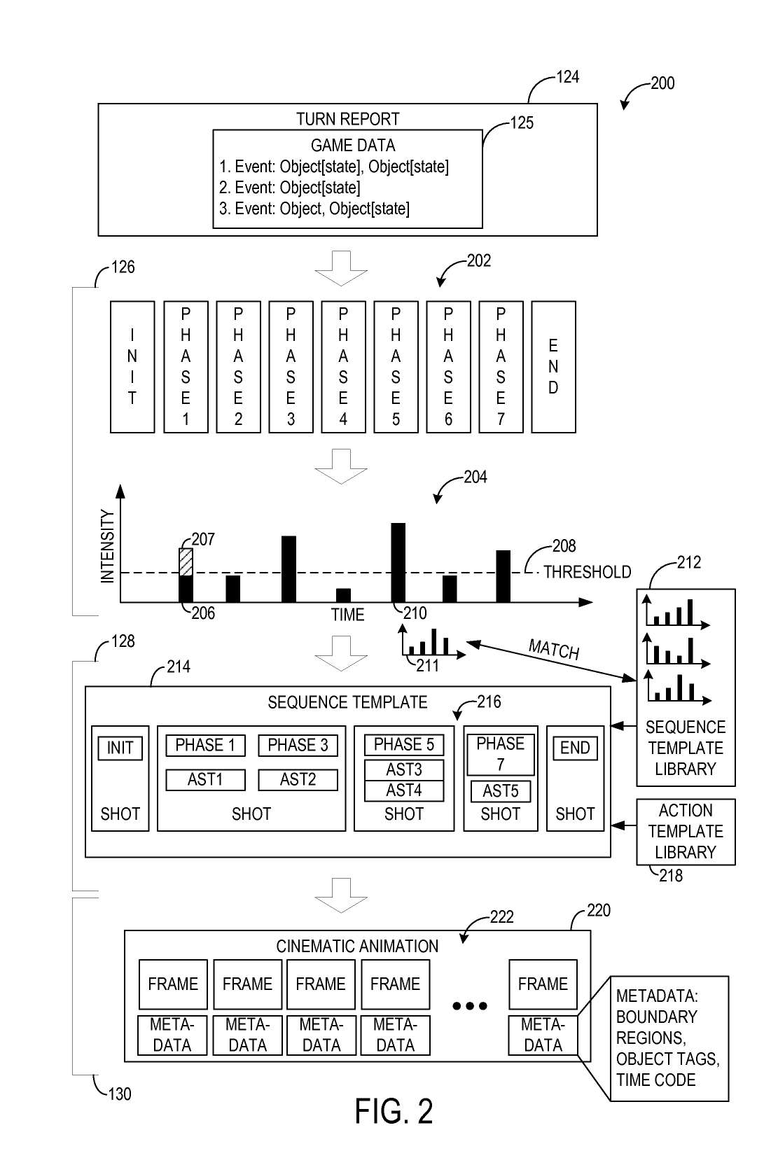

Turning now to FIG. 2, an embodiment of a software processing pipeline 200 is schematically shown, which may be implemented by system 100. As illustrated, turn report 124 includes game data 125 which in turn includes a plurality of events that have occurred during a turn of the game. Each event in the turn affects a number of associated game objects. For example, events may include the creation of game objects, destruction of game objects, and a change in the state of game objects. Thus, the turn report may include a list of events that occurred in a turn, and the objects associated with each event, and the state of each object at the conclusion of the event.

The first event in the turn report is typically an initialization event (INIT), which contains the objects involved in the turn and their initial state at the commencement of the turn. The final event in the turn report typically is the end event (END), which contains all game objects affected by the turn and their end state at the conclusion of the turn. The various intermediate events may represent events of game play such as creation of game objects, movement of game objects within the gamespace, battles and other interactions between game objects, destruction of game objects, etc. In this way, turn report 124 is an exhaustive list of all game events that occurred during a turn of the game, and their effect on game objects.

Returning to FIG. 1, program 104 includes a phase intensity scoring engine 126 configured to receive turn report 124 at a conclusion of a turn, divide it into phases, and score the intensity of each phase, so that an animation sequence template may be selected later that matches the intensity profile of the turn. The phase intensity scoring engine 126 may segment turn report 124 into a plurality of turn phases 202, shown in FIG. 2, by arranging the turn phases in sequential order as they occurred within the turn. It will be appreciated that turn-based games occur asynchronously, and thus the order of game events cannot be simply based upon the timing of user input in real-time game interactions. Rather, game engine 114 orders the events in the turn report according to game rules 116. These game rules might include randomizing the order of player moves, moving game objects prior to conducting battles or other interactions between the objects, etc.

The phase intensity scoring engine 126 groups one or more related events together according to programmatic rules into phases 202, and then computes a temporal duration for the phase. Thus, the phases are ordered, and each phase represents a time period in a turn. Although in FIG. 2 the turn phases are illustrated as being of equal width corresponding to equal temporal durations, it will be appreciated that the duration of each phase may vary.

The scoring engine 126 is configured to compute an intensity graph 204 for the turn corresponding to turn report 124. Intensity graph 204 includes an intensity score for each turn phase in turn report 124, which in the depicted example yields seven intensity scores. Each intensity score, for example intensity score 206, is determined based upon game events in its respective turn phase. Intensity scores may be, for example, percentages or integers, though any suitable numerical or symbolic representation may be used without departing from the scope of this disclosure. Intensity scores may represent the relative importance of game events in a turn phase and assist program 104 in prioritizing which game events are later conveyed to players as summaries of turns in the form of cinematic animations. As one non-limiting example, events including the destruction of game objects may be of relatively higher importance to the game and of higher importance to display to a player. As such, scoring engine 126 may assign a higher intensity score in response to a turn phase in which such an event occurs.

Scoring engine 126 may establish a threshold 208 and identify a subset 211 of turn phases in intensity graph 204 having at least threshold intensity scores. Alternatively or in addition, the subset of turn phases may be identified as those predetermined number or percentage of turn phases having higher intensity scores than a remainder of the turn phases. In such an embodiment, only the turn phases having at least threshold intensity scores are considered for potential conveyance in a cinematic animation. In this example, subset 211 comprises four phases for consideration. Threshold 208 may assist program 104 in omitting events which are inconsequential and/or uninteresting to players. In other embodiments, the scoring engine may score all phases in a turn, rather than a subset.

Scoring engine 126 may be further configured to determine intensity scores for each turn phase by assigning a bonus intensity score to foreshadowing phases. A foreshadowing phase is a turn phase in which a game object first appears in the turn, which later appears in a turn phase that is assigned a high intensity score above threshold 208. Such a game object may be referred to as a “key” game object. Scoring engine 126 identifies foreshadowing phases by determining one or more key game objects involved in a high scoring phase of the turn phases, where the high scoring phase has an intensity score above a threshold score (e.g., threshold 208). Scoring engine 126 then assigns a bonus intensity score to an earlier phase than the high scoring phase, where the earlier phase includes the same key game objects. Thus, in the example shown in FIG. 2, intensity score 206 is supplemented with a bonus intensity score 207 represented by the diagonally cross-hatched region, as its corresponding turn phase includes the same key game objects as a high scoring turn phase having a high intensity score 210. It will be appreciated that were it not for the bonus score 207, the phase which earned intensity score 206 would not have been exceeded the intensity threshold 208. Thus, the bonus intensity score may help ensure that the foreshadowing phase is not left out of the animation cinematic depicting the turn.

Returning to FIG. 1, program 104 includes a sequencing engine 128 configured to receive the output from phase intensity scoring engine 126. Turning to FIG. 2, sequencing engine 128 specifically receives subset 211 from scoring engine 126, though in other embodiments sequencing engine 128 may receive the entire intensity graph 204. Sequencing engine 128 is configured to select a sequence template from a template library 212 to match at least the intensity scores for the identified subset 211 of the plurality of turn phases 202. By way of example, template library 212 may include dozens or even hundreds of sequence templates, which describe a general, high-level progression of game events. As a non-limiting example, such a progression may include in the following order: a context-establishing event, an instigating event, a conflict event, and a victory event. Sequence templates exhibiting various other combinations of these events and other events may be provided as well.

Sequencing engine 128 may employ a plurality of suitable methods to select an appropriate sequence template which matches subset 211 received from phase intensity scoring engine 126. As described above, sequencing engine 128 may match the intensity scores of subset 211 with those in a sequence template selected from template library 212. This matching may be achieved by matching the intensities of each phase in subset 211 relative to one another. Thus, the overall shape of subset 211 will be matched to a similarly shaped sequence template. Moreover, a sequence template may be selected based on the time duration of each phase in subset 211 as compared to the overall duration of subset 211. In this way, a sequence template may be selected which accurately matches the general event progression in subset 211 and the duration of each phase within the overall duration of the turn.

In the illustrated example of FIG. 2, sequencing engine 128 has selected a sequence template 214 that matches subset 211. Sequence template 214 includes a plurality of shot elements 216, which serve as temporary placeholders to be replaced with rendered animations specific to subset 211. In particular, sequencing engine 128 replaces the plurality of elements 216 with turn phases having high intensity scores. In this example, the turn phases identified in subset 211 (phases 1, 3, 5, and 7) are identified in order to populate sequence template 214 as they have high intensity scores which exceed threshold 208. Typically, the INIT phase and END phase are also included in corresponding INIT and END shots, at which the rendered animation will begin and end. The mapping of intermediate phases to shots in the sequence template occurs due to mapping rules. These mapping rules may simply be 1:1 phase to shot mappings, or in some cases a plurality of phases may be mapped to s single shot, per the mapping rules for each sequence template. It will be appreciated that in some examples, not all phases in the subset 211 are included in the sequence template.

Having populated the plurality of elements 216 in sequence template 214 with the identified phases per the mapping rules for the selected sequence template, sequencing engine 128 selects at least one action sequence template (AST) from an action template library 218 for each identified phase. Like the placeholder elements of sequence template 214 before population with phases, ASTs provide a general high-level outline for animation sequences. For example, an AST may describe a movement path in a cinematic animation for a game object as well as its orientation in the animation. An AST may also specify a camera orientation controlling the perspective from which a cinematic animation is rendered. As one specific, non-limiting example, an AST may depict the high-level progression of a dogfight event in which two game objects engage intensely in battle, or an artillery barrage event in which a game object is bombarded with a large number of destructive game objects (e.g., missiles). Of course, templates may also exist for numerous other action sequences.

Once each sequence template 214 is populated with at least one action sequence template for each turn phase, sequencing engine 128 then creates an action sequence instance (ASI) for each AST. An ASI may be created for a given AST based upon game data for the turn phase associated with that AST. More specifically, an ASI may be produced by populating an AST with one or more game objects and one or more predefined camera motions for the associated turn phase. Continuing with the non-limiting artillery barrage example introduced above, twenty yellow game objects have facilitated the artillery barrage, firing missiles from left-to-right in the virtual gamespace. For this example, an ASI may be produced by populating the associated AST with the number and color of the game objects and a camera motion panning from left-to-right. Although examples have been given in which templates are populated with visual elements, it will be appreciated that the same methods described above to populate templates may be applied equally to audio elements, including music and sound effects.

Having been populated with ASIs, sequence template 214 comprises a plurality of shots, which number five in the example shown in FIG. 2. The shots provide a conceptualization of the structure of a cinematic animation to be rendered. Each shot may differ, for example, by the camera orientations used to render them, their game objects, and their duration, though these examples are non-limiting.

In this way, sequence template library 212 and action template library 218 may be leveraged to select high-level general descriptions of game event progressions, reducing or eliminating the need to program or otherwise configure ahead of time cinematic animations for every game event. Customization of cinematic animations may be tailored to the particular aspects of game events, however, increasing the dramatic effect and interest to players.

Returning to FIG. 1, program 104 includes a rendering engine 130 configured to render ASIs for each turn phase in the sequence template to produce a customized cinematic animation based on the output received from sequencing engine 128. Rendering engine 130 may include any suitable hardware for rendering two and/or three-dimensional graphics, and may employ any suitable rendering techniques. Further, rendering engine 130 may render ASIs according to predetermined animation contiguity rules 132. The animation contiguity rules improve the quality of a rendered cinematic animation and may assist rendering engine 130, for example, in maintaining a camera orientation between shots, maintaining the direction in which game objects travel between shots, etc.

Turning now to FIG. 2, rendering engine 130 is shown rendering a cinematic animation 300 comprising a plurality of frames 222. The plurality of frames 222 is based on the ASIs populated in sequence template 214, thereby customizing cinematic animation 300 to the turn phases identified in subset 211. As a result of such customization, a large variety of cinematic animations may be rendered by rendering engine 130 to visually represent various game turns. It will be understood that rendering engine 130 may render one or more ASIs sequentially to produce a continuous cinematic animation. Alternatively or additionally, rendering engine 130 may layer one or more ASIs on top of one another such that multiple ASIs are rendered in one or more frames in the plurality of frames 222. Although rendering engine 130 is shown as part of server 102, it will be appreciated that client devices 110 may instead include rendering engine 130 and render cinematic animations. Moreover, rendering engine 130 may output additional information regarding rendered cinematic animation 300.

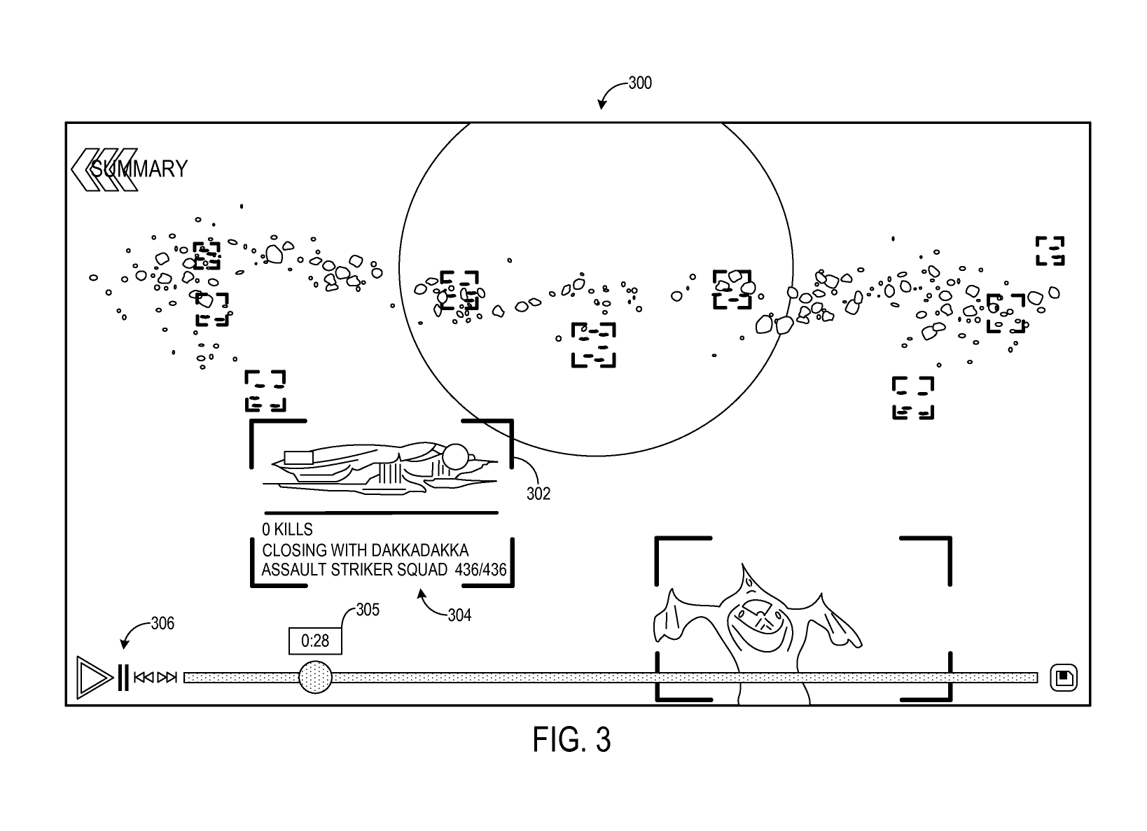

Turning now to FIG. 3, an exemplary cinematic animation 300 is shown. Cinematic animation 300 is the output of rendering engine 130 according to animation rules 132, based on the output received from sequencing engine 128. As shown in the illustrated example, a plurality of game objects as well as the virtual gamespace are rendered. In some embodiments, rendering engine 130 is configured to encode in the rendered cinematic animation 300 one or more boundary regions, for example boundary region 302 which is presented by brackets. Boundary region 302 may be selected by a player to display additional information based on one or more object tags encoded by rendering engine 130 in cinematic animation 300, for example object tag 304. In this example, object tag 304 identifies its corresponding game object and its health with the text “ASSAULT STRIKER SQUAD 436/436”. Object tag 304 further lists its corresponding game object's number of kills (“0 KILLS”) and current orders (“CLOSING WITH DAKKADAKKA”). Object tags are associated with boundary regions, and in some examples, rendering engine 130 may encode one or more object tags associated with a boundary region for each boundary region in cinematic animation 300, in a single file, as shown in FIG. 2. In other embodiments, it will be appreciated that metadata comprising boundary regions and object tags may be encoded in a file separate from that in which cinematic animation 300 is encoded without departing from the scope of this disclosure.

Returning to FIG. 3, cinematic animation 300 may further have a time code 305 associated with, and linking each boundary region and object tag to one or more frames in cinematic animation 300. If a player selects boundary region 302, for example, additional information about its corresponding game object may be displayed based on the associated time code 305. In this way, game objects may be located and tracked throughout each frame in cinematic animation 300, and further linked to individual turn phases.

FIG. 3 further shows a set of controls 306 which may be selected by a user to alter various aspects of cinematic animation 300. Controls 306 may, for example, allow a player to play back, rewind, pause, and cycle through cinematic animation 300 in a frame by frame manner.

Returning to FIG. 1, once rendering engine 130 has rendered cinematic animation 300, program 104 outputs cinematic animation 300 to client devices 110, such as desktop client device 110A and mobile client device 110B over network 108. In particular, cinematic animation 300 may be outputted to displays 111 of devices 110 such that cinematic animation 300 may be viewed and engaged by players. It will be appreciated that the cinematic animation 300 is typically transmitted from the server 102 to a game client 115 executed on each device 110, and displayed in a graphical user interface (GUI) 113 of the game client 115 on display 111. It will be appreciated that typically, a different cinematic animation is generated for each player participating in the turn based game; however, depending on the type of game, it may be desirable to transmit the same cinematic animation to more than one player. Controls 306 shown in FIG. 3 may be displayed by client devices 110, along with the cinematic animation 300. The display of controls 306 may be toggled on and off by a player, for example a player using client device 110. Alternatively or additionally, controls 306 may disappear after not receiving input for a threshold duration from an associated device and reappear upon receiving input. In this manner, the player may selectively repeat and replay portions of the cinematic animation, at the player's discretion.

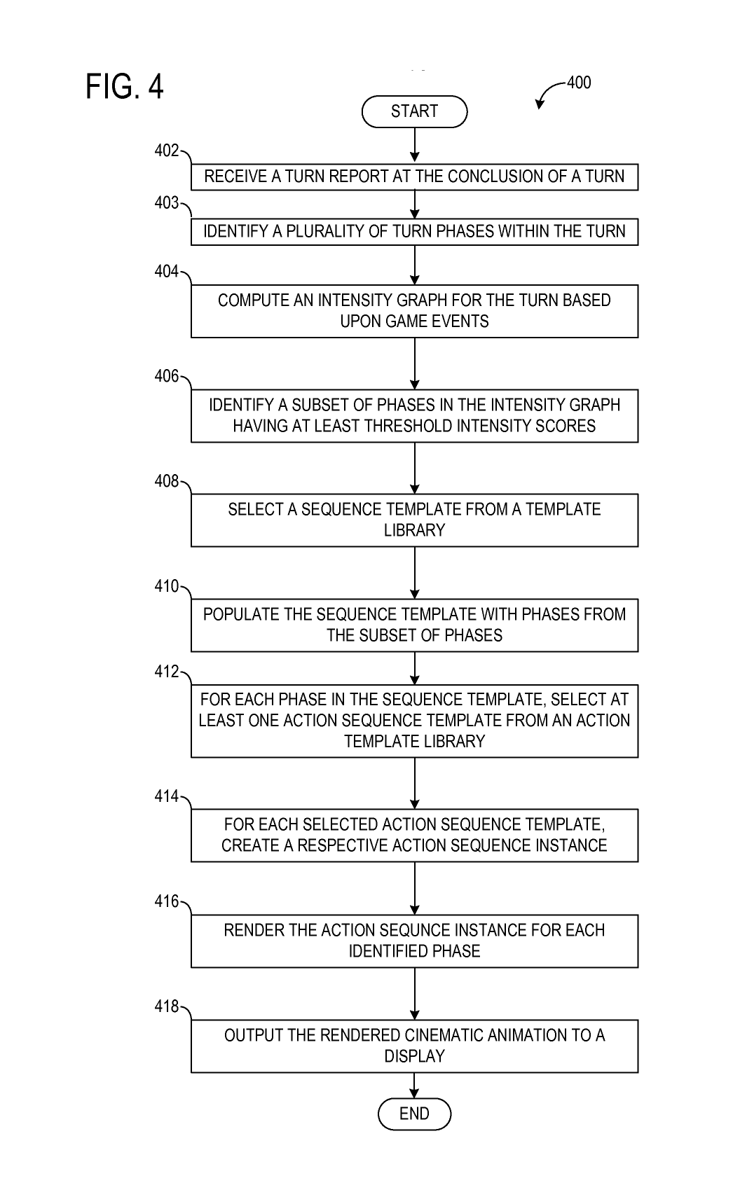

Turning now to FIG. 4, a method 400 is shown for computationally generating cinematic animation 300. Method 400 may be carried out, for example, by system 100 described above, or other suitable computing devices.

At 402 of method 400, the method may include receiving a turn report at the conclusion of a turn in a turn-based game program. At 403, the method may include identifying a plurality of turn phases in sequential order within the turn report. Each turn phase may have a temporal duration and may include one or more game events (e.g., game object destruction).

At 404, the method may include computing an intensity graph (e.g., intensity graph 204) the turn. The intensity graph includes an intensity score (e.g., intensity score 206) for each turn phase that is determined based upon the game events in that turn phase.

At 406, the method includes identifying a subset (e.g., subset 211) of phases in the intensity graph having at least threshold intensity scores, or as the predetermined number or percentage of phases having intensity scores higher than a remainder of the phases in the intensity graph. In some embodiments, this step is omitted, and intensity scores for all identified phases are used in downstream processing.

At 408, the method includes selecting a sequence template (e.g., sequence template 214) from a template library (sequence template library 212) to match at least the intensity scores for the identified subset of phases. At 410, the method includes populating the selected sequence template with the phases identified at 406.

At 412, the method includes selecting at least one action sequence template (e.g., AST1 in FIG. 2) for each identified phase from an action template library (e.g., action template library 218). At 414, the method includes creating a respective action sequence instance for each selected action sequence template, based upon game data for the phase associated with the selected action sequence template.

At 416, the method includes rendering the action sequence instance for each identified phase according to predetermined animation contiguity rules (e.g., animation rules 132). The rendering is performed to thereby produce the cinematic animation (e.g., cinematic animation 300) for the turn of the turn-based game program. Finally, at 418, the method includes outputting the rendered cinematic animation to a display (e.g., display 111). This outputting may involve transmitting the rendered cinematic over a computer network such as a wide area computer network, to a client device, for display on the display of the client device.

FIG. 5 schematically shows a non-limiting embodiment of a computing device 500 that can be used for the server or client devices of the system described above, and which can be used to implement the methods described above. Computing device 500 is shown in simplified form. It will be understood that virtually any computer architecture may be used without departing from the scope of this disclosure. In different embodiments, computing device 500 may take the form of a mainframe computer, server computer, desktop computer, laptop computer, tablet computer, home-entertainment computer, network computing device, gaming device, mobile computing device, mobile communication device (e.g., smart phone), etc.

Computing device 500 includes a logic subsystem 502, volatile memory 303, and a non-volatile storage subsystem 504. Computing device 500 may also include a display subsystem 508, input subsystem 506, and communication subsystem 510, and/or other components not shown in FIG. 5.

Logic subsystem 502 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Volatile memory 503 may include devices such as RAM that are used to temporarily contain data while it is being processed by the logic subsystem. It will be appreciated that data stored in volatile memory 503 is typically lost when power is cut.

Non-volatile storage subsystem 504 includes one or more physical devices configured to hold data and/or instructions in a non-volatile manner to be executed by the logic subsystem to implement the methods and processes described herein. Non-volatile storage subsystem 504 may include computer readable media (e.g., CD, DVD, HD-DVD, Blu-Ray Disc, FLASH memory, EEPROM, ROM, etc.), which may include removable media and/or built-in devices that hold instructions in a non-volatile manner, and thus continue to hold instructions when power is cut to the device. Non-volatile storage subsystem 504 may include other storage devices such as hard-disk drives, floppy-disk drives, tape drives, MRAM, etc.).

In some embodiments, aspects of the instructions described herein may be propagated over a communications medium, such as a cable or data bus, in a transitory fashion by a pure signal (e.g., an electromagnetic signal, an optical signal, etc.) that is not held by a physical device for a finite duration.

The terms “module,” “program,” and “engine” may be used to describe a software aspect of computing device 500 implemented to perform a particular function. In some cases, a module, program, or engine may be instantiated via logic subsystem 502 executing instructions held by non-volatile storage subsystem 504, using portions of volatile memory 503. It will be understood that the terms “module,” “program,” and “engine” may encompass individual or groups of executable files, data files, libraries, drivers, scripts, database records, etc.

Display subsystem 508 may include one or more displays, which may be integrated in a single housing with the remaining components of the computing device 500, as is typical of smart phone applications, laptop computers, etc., or may be separated and connected by a wired or wireless connection to the computing device, as is typical of desktop computers. The displays may be touch-sensitive for input, in some examples.

Input subsystem 506 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

Network interface 510 may be configured to communicatively couple computing device 500 with one or more other computing devices via a computer network, such as the Internet, utilizing a wired or wireless connection.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A turn-based game program executed on a computing device, comprising:
a phase intensity scoring engine configured to:
receive a turn report at a conclusion of a turn of the turn-based game program, the turn report including a plurality of game events,
determine a plurality of turn phases in sequential order within the turn, each turn phase including one or more of the game events;
compute an intensity graph for the turn, the intensity graph including an intensity score for each turn phase, each intensity score being determined based upon the game events in the corresponding turn phase; and
identify a subset of phases in the intensity graph having at least threshold intensity scores or having higher intensity scores relative to a remainder of the phases;
a sequencing engine configured to:
populate a sequence template with at least the subset of phases;
for each phase in the subset, select at least one action sequence template from an action template library; and
for each selected action sequence template, create a respective action sequence instance based upon game data for the phase associated with the selected action sequence template;
a rendering engine configured to:
render the action sequence instance for each phase in the subset, to thereby produce the cinematic animation for the turn of the turn-based game program; and
output the rendered cinematic animation to a display.

2. The game program of claim 1, wherein the game events in each turn phase are selected from the group consisting of:
creation of game objects;
destruction of game objects; and
change in state of game objects.

3. The game program of claim 1, wherein the phase intensity scoring engine is further configured to determine the intensity score for each turn phase by:
assigning a bonus intensity score to foreshadowing phases, the foreshadowing phases being identified by:
determining one or more key game objects involved in a high scoring phase of the turn phases which has an intensity score above a threshold score; and
assigning the bonus intensity score to an earlier phase than the high scoring phase, the earlier phase including the same key game objects.

4. The game program of claim 1, wherein the phase intensity scoring engine is further configured to select the sequence template from a template library including a plurality of sequence templates, to match the intensity scores of the phases.

5. The game program of claim 1, wherein the sequencing engine is further configured to populate the action sequence template with one or more game objects and one or more predefined camera motions for the associated phase, to produce the action sequence instance.

6. The game program of claim 1, wherein the rendering engine is further configured to:
encode in the rendered cinematic animation boundary regions and object tags associated with the boundary regions, each boundary region and object tag having associated therewith a time code linking each boundary region and object tag to one or more frames in the rendered cinematic animation.

7. The game program of claim 6, wherein each boundary region is configured to be selected by a player to display additional information based on the associated time code and one or more of the object tags.

8. The game program of claim 1, wherein the determined intensity score is higher in response to game object destruction.

9. The game program of claim 1, wherein the sequencing engine is further configured to select the sequence template to match intensities of each phase in the subset relative to one another.

10. A method for computationally generating a cinematic animation in a turn-based game program, the method comprising:
receiving a turn report at a conclusion of a turn of the turn-based game program, the turn report including a plurality of game events;
determining a plurality of turn phases in sequential order within the turn, each turn phase including one or more game events;
computing an intensity graph for the turn, the intensity graph including an intensity score for each turn phase that is determined based upon the game events in that turn phase;
identifying a subset of phases in the intensity graph having at least threshold intensity scores or having higher intensity scores relative to a remainder of the phases;
populating the sequence template with phases from the subset of phases;
for each phase in the sequence template, selecting at least one action sequence template from an action template library;
for each selected action sequence template, creating a respective action sequence instance based upon game data for the phase associated with the selected action sequence template;
rendering the action sequence instance for each identified phase, to thereby produce the cinematic animation for the turn of the turn-based game program; and
outputting the rendered cinematic animation to a display.

11. The method of claim 10, wherein the game events in each turn phase are selected from the group consisting of:
creation of game objects;
destruction of game objects; and
change in state of game objects.

12. The method of claim 10, wherein the intensity score for each turn phase is determined by:
assigning a bonus intensity score to foreshadowing phases, the foreshadowing phases being identified by:
determining one or more key game objects involved in a high scoring phase of the turn phases which has an intensity score above a threshold score; and
assigning the bonus intensity score to an earlier phase than the high scoring phase, when the earlier phase includes the same key game objects.

13. The method of claim 10, further comprising:
selecting the sequence template from a template library to match the intensity scores for at least a subset of phases;

14. The method of claim 10, wherein the action sequence template is populated with one or more game objects and one or more predefined camera motions for the associated phase, to produce the action sequence instance.

15. The method of claim 10, further comprising:
encoding in the rendered cinematic animation boundary regions and object tags associated with the boundary regions, each boundary region and object tag having associated therewith a time code linking each boundary region and object tag to one or more frames in the rendered cinematic animation.

16. The method of claim 15, wherein each boundary region is configured to be selected by a player to display additional information based on the associated time code and one or more of the object tags.

17. The method of claim 10, wherein the rendered cinematic animation may be played back, rewound, paused, and cycled through in a frame by frame manner.

18. The method of claim 10, wherein the determined intensity score is higher in response to game object destruction.

19. The method of claim 10, wherein the sequence template is further selected to match intensities of each phase relative to one another.

20. A method for computationally generating a cinematic animation in a turn-based game program, the method comprising:
receiving a turn report at the conclusion of a turn of the turn-based game program, the turn report including a plurality of game events;
determining a plurality of turn phases in sequential order within the turn, each turn phase having a temporal duration and including one or more game events;
computing an intensity graph for the turn, the intensity graph including an intensity score for each turn phase that is determined based upon the game events in that turn phase and supplemented with a bonus intensity score to foreshadowing phases, the foreshadowing phases being identified by:
determining one or more key game objects involved in a high scoring phase of the turn phases which has an intensity score above a threshold score; and
assigning the bonus intensity score to an earlier phase than the high scoring phase, when the earlier phase includes the same key game objects;
identifying a subset of phases in the intensity graph having at least threshold intensity scores;
selecting a sequence template from a template library to match the intensity scores and temporal durations for the identified subset of phases;
populating the sequence template with the identified phases;
for each identified phase, selecting at least one action sequence template from an action template library;
for each selected action sequence template, creating a respective action sequence instance based upon game data for the phase associated with the selected action sequence template;
rendering the action sequence instance for each identified phase according to predetermined animation contiguity rules, to thereby produce the cinematic animation for the turn of the turn-based game program;
encoding in the rendered cinematic animation boundary regions and object tags associated with the boundary regions, each boundary region and object tag having associated therewith a time code linking it to one or more frames in the rendered cinematic animation; and
outputting the rendered cinematic animation to a display.
